(19) United States
(12) Patent Application Publication
(10) Pub. No.: US 2014/0164287 A1
(43) Pub. Date: Jun. 12, 2014

(54) NEEDS-BASED SUGGESTION ENGINE

(71) Applicant: CapitalRock LLC, North Salt Lake, UT (US)

(72) Inventors: John C. HYDE, North Salt Lake, UT (US); Brian L. HENDRICKS, Kaysville, UT (US)

(73) Assignee: CapitalRock LLC, North Salt Lake, UT (US)

(21) Appl. No.: 13/951,097

(22) Filed: Jul. 25, 2013

Related U.S. Application Data
(60) Provisional application No. 61/675,689, filed on Jul. 25, 2012.

(51) Int. Cl. G06Q 40/06

(52) U.S. Cl. CPC G06Q 40/06
USPC 705/36 R

(57) ABSTRACT

A system for generating needs-based suggestions which includes a computing device. The computing device is configured to gather key financial data for at least one user, analyze the key financial data to perform at least one of generating questions directed at identifying additional key financial data and selecting at least one suggestion based on the key financial data, and generate an electronic message including the at least one suggestion and a detailed explanation of reasons the at least one suggestion was selected based on the key financial data.

### CROSS-REFERENCE TO RELATED APPLICATIONS

This application claims priority to U.S. Patent Provisional Application No. 61/675,689, filed Jul. 25, 2012, titled “NEEDS-BASED SUGGESTION ENGINE,” and that application is incorporated herein by reference in its entirety.

### BACKGROUND OF THE INVENTION

1. The Field of the Invention

The present invention relates to system and methods for providing suggestions related to financial planning, including financial products, services and topics with detailed reasons why the suggestions are relevant to the client. More specifically, the present invention provides to systems and methods for providing client specific financial planning suggestions or recommendations based on the particular needs of a client.

2. The Relevant Technology

Previous attempts at providing client specific financial planning suggestions or recommendations took either a comprehensive financial planning approach where a complete client fact finder specific to an individual had to be completed and analyzed by a financial professional or a generalized approach where propensity or analytical models were used to generate banner ads, direct mail campaigns, or lists of client opportunities which were presumed to apply to a targeted marketing audience.

In the comprehensive financial planning approach, the financial planning process typically takes at least two to three client interactions to gather a great deal of data and the process is time consuming and difficult to complete online. Clients are often overwhelmed and frustrated by the process. Additionally, the comprehensive financial planning approach can also generate a large quantity of suggestions that a client needs to enact on to get their financial plans implemented, which can often overwhelm the client and cause them to take no action.

Firms for the most part have put financial calculators or generic libraries of content on their websites to help their clients determine their financial needs in areas of insurance, risk management, wealth management and portfolio management. Many times clients don't know what areas of their financial lives to focus on and therefore can't determine where they need help. Other inventions or solutions include algorithms or propensity models to try and identify clients or prospect that fit a specific model or target group for a suggestion or product i.e. retirement distribution planning or long term care insurance. Using a propensity or algorithmic approach uses data from clients that have bought a product or service in the past and compares that data to data on other individuals in client data warehouse or data management system and identifies clients with a common set of data characteristics and generate a list of possible targets for a given product or service. The propensity or analytical model approach typically generates a direct mail, an online offer or a list of opportunities. The success rate of this approach is low and has limited success in the financial services market.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to systems and methods for providing needs-based financial planning recommendations.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

A first aspect of the invention is a system for generating needs-based suggestions. The system comprises a computing device configured to perform operations including gathering key financial data for at least one user, analyzing the key financial data to perform at least one of generating questions directed at identifying additional key financial data and selecting at least one suggestion based on the key financial data, and generating an electronic message including the at least one suggestion and a detailed explanation of reasons the at least one suggestion was selected based on the key financial data.

A second aspect of the invention is a processor configured to execute computer instructions to cause a system to perform operations to determine at least one suggestion. The operations comprise gathering key financial data for at least one user, analyzing the key financial data to perform at least one of generating questions directed at identifying additional key financial data and selecting at least one suggestion based on the key financial data, and generating an electronic message including the at least one suggestion and a detailed explanation.

A third aspect of the invention is A method for generating at least one suggestion, the method comprising requesting financial or personal information to obtain key data relating to at least one user, analyzing the key data to determine suggestions relevant to the at least one user, prioritizing the suggestions in order of relevance to the at least one user based on the financial or personal information, and providing at least one of an explanation and a reason for each suggestion.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic diagram illustrating an embodiment of the function of a needs based suggestion;

FIGS. 2A through 2J illustrate examples of outputs of the needs-based suggestion engine;

FIG. 3 shows an example of an electronic message that may be sent to a financial agent;

FIG. 4 is a flow chart which illustrates a method of the invention according to an alternative embodiment;

FIGS. 5-6 illustrate a graphed scoring profile; and

FIG. 7 is an example of a graphed scoring profile score.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Some embodiments described herein relates to systems and methods for identifying needs-based financial planning suggestions for users (e.g., clients and potential clients). The system may include a suggestion engine that generates and prioritizes the suggestions. The suggestions may be made directly to a user when the user logs in to a financial services website or access company information through a website. The suggestions may be present as a component of the website and/or may be presented to a financial services professional that then communicates with the user. The design of the system thus enables the suggestions to be explained and communicated directly to the user.

Such users of financial services firms are looking for their firm to provide personalized financial advice and recommendations on their financial needs and priorities through online interactions. The system is designed to either take current customer and product information from a current data management system or collect customer and product information and analyze the information and score, rank and explain the top financial priorities that the user ought to focus on. When the user clicks on a suggestion in the system a description of why that particular suggestion may be relevant to the user is explained in user specific reasoning text that includes demographic and product information, client specific calculations and other relevant facts that explain the suggestions to the user as part of this reason text.

In contrast, conventional systems use more of a “black box” approach which does not provide client specific reasons and calculations that explain why suggestions may be a good fit for a given customer or prospect. Rather, such systems typically generate a list of candidates for a marketing campaign, banner ad or a direct mail campaign.

The systems and methods described wherein provide a unique and novel way of providing client specific suggestions to the user complete with all the detailed reasons and calculations of why the suggestion or recommendation may be relevant to the user. It is not enough to identify a suggestion or recommendation to a client or prospect. Most people don't act on financial decisions until they understand why they are important and how the analysis was done, therefore using detailed reason text to explain to the client why a particular suggestion makes sense and is relevant is key to success. The systems and methods described herein take a unique approach to the process and provide client specific reasons and calculations that educate the client and therefore will produce higher level of acceptance and results.

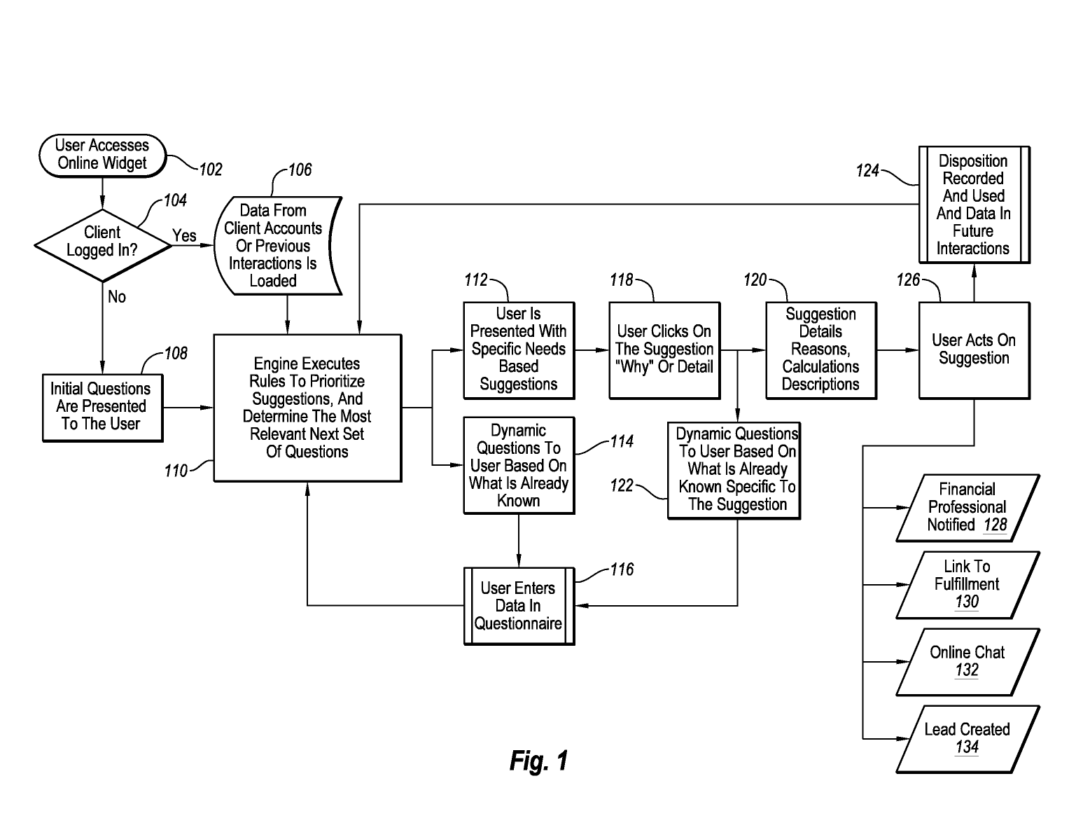

FIG. 1 is a schematic diagram illustrating an embodiment of a system to provide at least one suggestion specific to a user (e.g., a client or prospective client), arranged in accordance with at least some embodiments described herein. When implemented at least partially in software, the system may include a computing device or suggestion engine having a processor and a memory configured to execute computer instructions stored in the memory to cause the computing device or suggestion engine to perform the operations described herein. The suggestions may be based on information collected from the user, or alternatively or in addition to, information obtained from the user's account on a website, such as a client's website. The system may also provide reasons or details pertaining to the suggestion, which may be referred to herein as “reason text,” and may also store the user's actions and generate electronic messages or alerts which may be transmitted to a financial professional.

As shown in FIG. 1, at 102 the user may access the system through an online widget, which may be a software application installed and executed within a web page by the user. For example, the web page of a client, such as an insurance company, financial advisor, bank or the like.

As a non-limiting example, the user may have an account with the client such that the client may login in to the web site at 104. Once the client has logged in, data from the account or from the user's previous interactions with the web site may be loaded at 106. The account data is loaded into the system from existing client information systems using a data warehouse, or client management system.

As another non-limiting example, at 108 one or more initial questions may be presented to the user. The initial questions may be presented to the user via an interface displayed within the website or on a separate web page or pop up launched from the web site. The interface may present the questions in a format that enables the user to easily provide a response. For example, the user may utilize a mouse or touch screen to select sliders, buttons and/or check boxes to provide their response to each of the questions. The initial questions prompted by the system may be, for example, income, age, marital status and number of dependents.

At 110, the answers to the initial or preliminary questions are analyzed and based on these the input of these initial questions calculations will be completed and the recommendation engine may execute rules and prioritize a series of preliminary suggestions which may be presented to the user at 112. Additionally, the recommendation engine may generate an additional list of questions related to specific suggestions being made by the system and present them to the client at 114. The subsequent questions are dynamic and are determined by the responses to the initial questions. For example, if it is determined that a user that is elderly by the initial questions, the user will not be asked questions about funding their own college, but rather may be asked questions related to long-term care insurance, life insurance, medical insurance, health care insurance and the like.

At 116, as the user continues to enter data and answer the dynamic questions, the recommendation engine may continually update the recommendations at 112 and ask additional dynamic questions at 114.

The system may analyze all or at least a portion of available information, including the user's account information and the responses provided by the user to identify key data that is used to rank and score suggestions. Suggestions are scored based on multiple factors that may include, for example, demographics, age, income, marital status, account sizes, existing holdings, number and ages of dependents, types of investment holdings including assets classes, policy types, qualified vs. non-qualified assets, previous interaction data including other suggestions accepted and rejected and/or indications of recent life events (e.g., marriage, job change, death, etc.). This is also coupled with user preference information that may be gathered such as attitudes about risk and flexibility. Such suggestions may include, for example, insurance and financial products and services. By way of example and not limitation, the suggestions may include retirement plans, managed accounts, long term care insurance, wills and trusts, tax planning, insured retirement income, insurance review, alternative investments, home equity line, asset allocation, mortgage refinance, and the like. Additionally, the suggestions may be service- or marketing-oriented suggestions that would suggest the user use other parts of the website such as planning tools, links to other marketing material and the like.

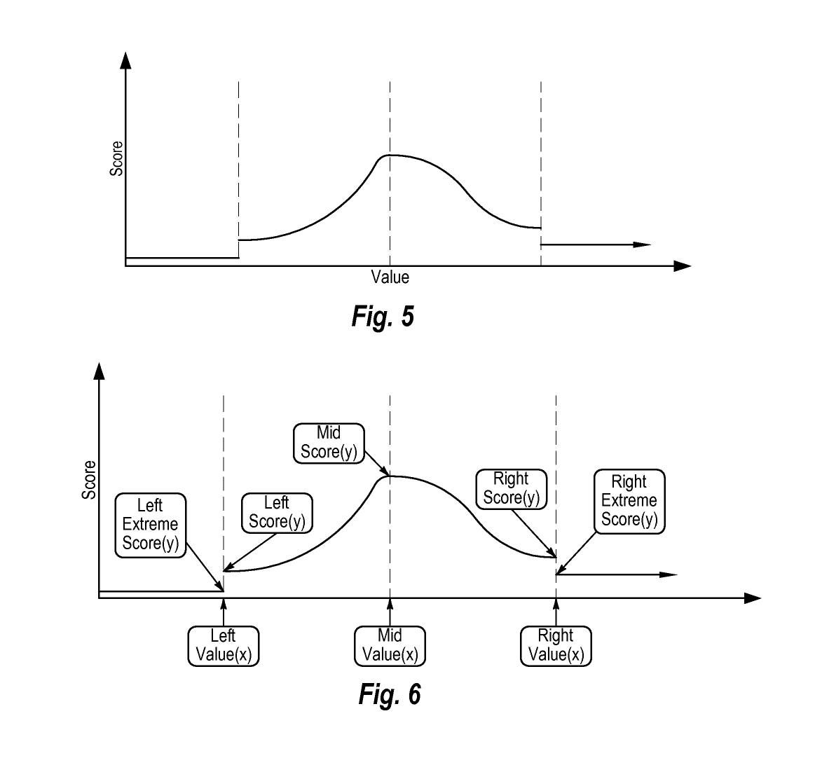

For example, the system may execute one or more rules to generate and/or prioritize the suggestions. Each rule may not be deterministic, but may contribute to or reduce the relevance of a suggestion. This scoring process creates a dynamic priority rather a simple decision tree process. Rules may be applied with different scoring to multiple suggestions. In example, the age of the client. For many of the scoring factors, curve scoring rules are used. This is a scoring approach that allows the score to gradually change as a user value changes. This is used where the user value can vary widely and “bracketing” the value does not accurately reflect the change in relevance. This may be the situation for age, income, assets, percent of insurance need filled and the like. A graphed scoring profile may be generated that reflects the results of the scoring process. For example, the graphed scoring profile may look like a modified normal distribution. An example of the graphed scoring profile is shown in FIG. 5.

In the graphed scoring profile shown in FIG. 5, for each of the points on the horizontal “x” axis, there is a parameter that controls the scoring profile. These parameter/values are as follows:

Left Extreme Score:

The score for all values less than the left value.

Left Value:

The target value on the left. Typically this is the lowest value acceptable scoring. In the case of income, it would be the lowest income acceptable for the bridge. Anything less may not be suitable.

Left Score:

The starting score for the left value.

Left Curve Factor:

Controls the shape of the curve. These are positive values. The larger the number the greater the “spike” near the midpoint. A lower number would be a gradual increase to the midpoint.

Mid Value:

The value at the midpoint. This is used in some cases as the “peak” or so-called “sweet spot.” In others it is a reference point on the way to the extreme.

Mid Score:

The score at the midpoint.

Right Value:

The top end value. This is used sometimes as the maximum recommended value or in others it is a target.

Right Score:

The score at the right value.

Right Curve Factor:

Controlling value of the right side curve. See left curve factor

Right Extreme Score:

Score beyond the right value.

These parameter/values are illustrated on the graphed scoring profile shown in FIG. 6.

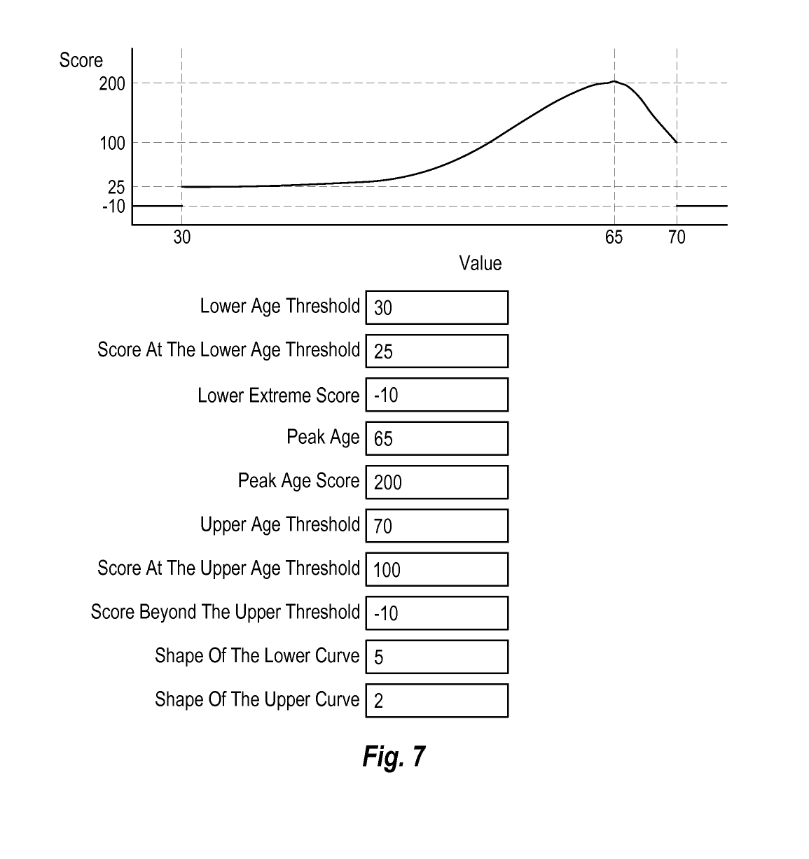

A settings page may be generated that includes scores correlating with the graphed scoring profile. Some examples of scores from the settings page are shown in FIG. 7.

In the example shown in FIG. 7, the peak age is age 65 and lower and upper threshold ages are respectively 30 and 70. Therefore, for ages less than 30 or over 70 the bridge is no longer relevant.

Life insurance shortfall scoring with a mid at 75% of insurance need met. The illustrated assumption is that, until the client has 75% of the recommended insurance, it is equally relevant. From 75% to 100%, it becomes decreasingly less relevant. Other rules may be more static, but each rule is combined with a relative score that applies to the relevance of the suggestion.

The suggestions may then be presented to the user at 112 or a relevant set of dynamic questions may be determined and presented to the user at 114 in order to obtain additional key data. For example, the relevant set of questions may include dynamic questions generated based on previously known information (e.g., the user's account information and the responses provided by the user). The system may prompt the user to add or update the key data. The dynamic questions may be configured to obtain information about the key data to do more in-depth analysis of needs specific to the user. Such data points may include age, change in marital status, purchasing a new home, having/adopting a child and changing jobs.

The information may be analyzed to determine the most relevant questions based on previous input. The relevant set of questions may be presented to the user via the interface, for example. A predetermined number of questions, such as one (1) through five (5) questions may be provided to the user at one time and the user may then be provided with updated results as a reward or incentive to provide the additional data prior to asking additional questions.

When complete information is not available, rule of thumb calculations may be used to generate the suggestions. The rule of thumb calculations may include any calculations now know or later developed. For example, rule of thumb calculations may be used when completing an analysis of a client's life insurance needs. As a non-limiting example, the rule of thumb calculations may be an industry specific rule of thumb that uses a multiple of the client's income based on a client's age, marital status and number of dependents to determine the total need without requiring the detailed capture of all of the client's assets and liabilities. The system automates and uses these multiples to generate reason text and identify the relevance of opportunities. To assess retirement needs, the rule of thumb may be to replace a certain percentage of income in retirement. Current assets are projected using a future value and compared to current income.

For example, the system may collect information about new life events and may then re-score the suggestions based on the new information entered driving real-time cross selling opportunities.

In embodiments in which the system includes a widget embedded into a client-facing website, the widget may be deployed in two ways: (1) at account login; and (2) at a consumer website. In embodiments in which the widget is launched when the user logs in to the client website, the widget may use the account information, which may include pre-populated data, to generate the suggestions. For example, the client website may be configured to allow the account login to get personal data from the account or pull data from personal financial management software.

In embodiments in which the widget is launched at a consumer website, the widget may be launched within the website and may provide questions to obtain the key data using a webpage of the website as the interface.

As is described more fully below, each of the suggestions may be presented with a ranking and accompanying text. The ranking may be presented to the user via a numbering or star system, for example, wherein a higher number indicates a higher priority or vice versa. The accompanying text may provide the user with a detailed explanation of the suggestions as well as the reason the suggestion was made to the client at 118.

Rather than merely restating the logic executed by the recommendation engine or providing a justifying statement, the detailed description may include client specific information and calculations at 120. This detailed description may include narrative explaining accepted financial practice and how it relates to the client specifically based on what is known about the client. The detailed description may contain hyperlinks to other resources or tools such as information libraries and other planning tools. Further the elements of the detailed description may be ranked or displayed according to their effect on the relevance of each suggestion. For example, the detailed description elements may have a contributing relevance score to the overall suggestion relevance score, both positive and negative. In this configuration, each scoring factor will provide a snippet of reason text or explanation.

Further, a single piece of information supplied by the user may be used in a variety of different calculations for a variety of different scoring methods. For example, a client's age may be used for a variety of different factors and may lead to multiple suggestions, each of which may have a unique detailed description at 120.

Additionally, at 122 the text may include specific questions related to each suggestion, the user's response to which may enable reordering of the suggestions based on the user's priorities. For example, a life events indicated by the user in response to the specific questions may be used to update the suggestions.

At 126, the user may then act the suggestion. For example, the user may be provided with a link to a financial professional, a request to have a financial professional follow up on the suggestion, or to an application for an insurance product, an enrollment process for financial product, access to online chat session, an offer to send more detailed product information, or the option decline the suggestion and receive additional relevant suggestions. A simple action may be to link to another part of the website.

The suggestions may be transmitted to a financial professional at 128 using, for example, an electronic message generated by the system. The user may be linked with the financial professional at 130 via an online chat 132 or instant messaging service enabling the user to obtain additional information about the suggestions or to obtain a product and the financial planner to establish a lead to a potential client at 134.

At 124, the disposition of the user may be recorded and used as data in future interactions. The disposition may include one or more of the following: no thanks/not interested, I like it/follow up with me later, contact my financial professional, send me more information, etc.

One of the biggest obstacles to overcome when selling financial products is helping potential clients prioritize and understand their financial needs. The system enables a client to walk current and potential clients through a straight-forward process to understand what they ought to be focused on and why, thus creating qualified opportunities. rules driven intelligence to identify and communicate personalized suggestions based on the individual clients needs not based on propensity models of what type of clients have bought the product in the past or the product-of-the-month. Thus, the system enhances the customer experience by providing needs-based product suggestions directly to the customer or prospect.

The system provides a unique online customer experience, personalized client specific suggestions to guide customers through the process and easy to understand reasons why each suggestion is recommended for the user. The system takes a proactive needs-based approach that improves loyalty and retention, leverages e-commerce and data warehousing investments and captures life events which influence the suggestions made by the system. The system may also generate and transmit alerts for follow-up complete with suggestion details and user data. The system, thus, enables consistent needs-based suggestions across an entire client-base and user-base.

The computing system may include the following parts: database, suggestion engine, context handler, web server, user interface (UI) render engine. The database holds loaded customer data, data collected from the customer, results of scoring and dispositions. The suggestion engine, ingests data, executes functions and calculations, applies scores and ranks suggestions. The suggestion engine also provides the triggers for additional questions. The context handler applies the appropriate reason text and suggestion content based on where the request is coming from. Contexts could be different languages, and different users. The webserver supports the web components that include the UI render engine. The UI render engine accepts question triggers from the engine and builds the input pages on the web dynamically personalizing the experience.

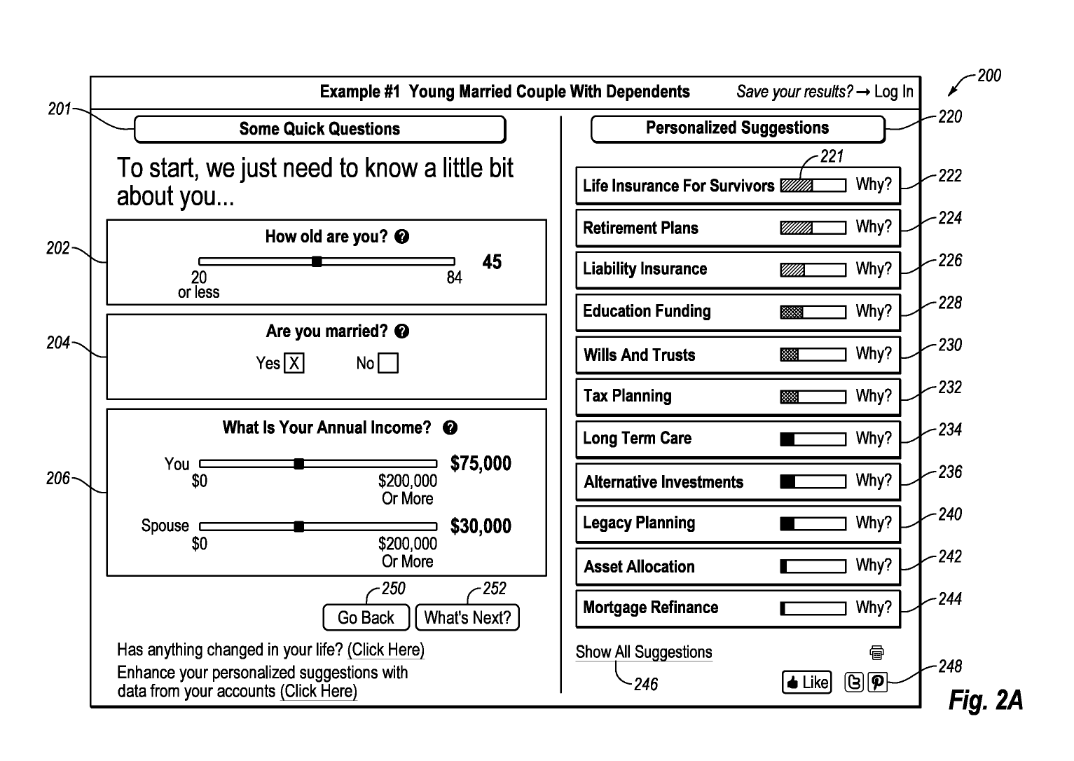

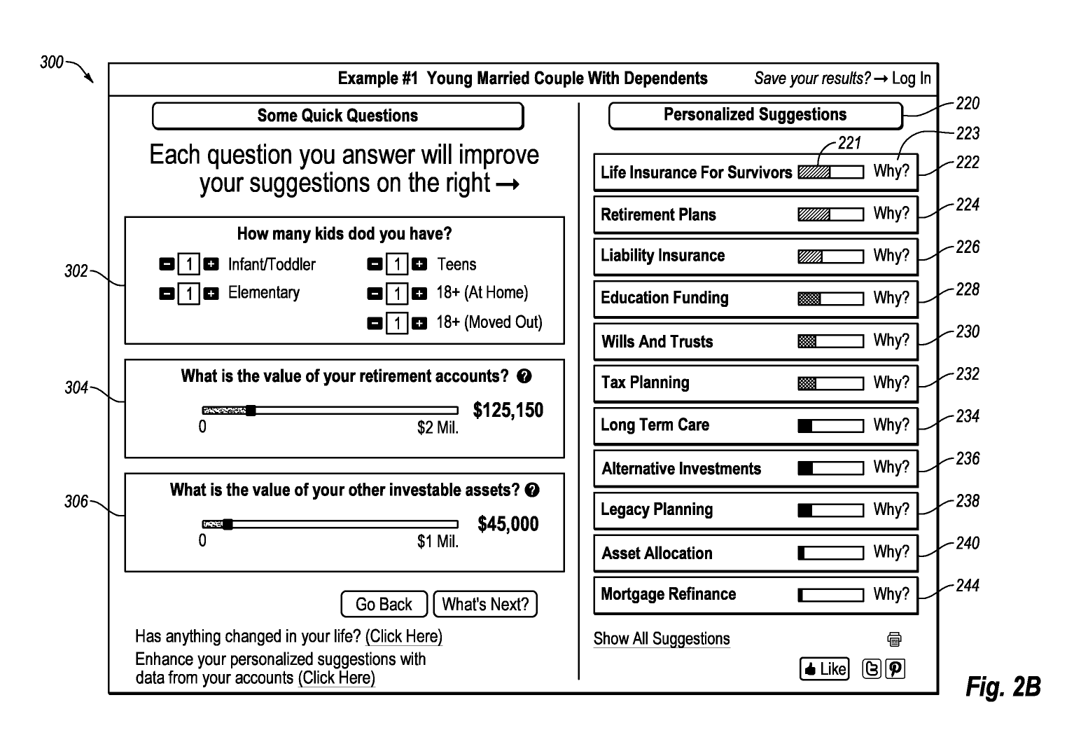

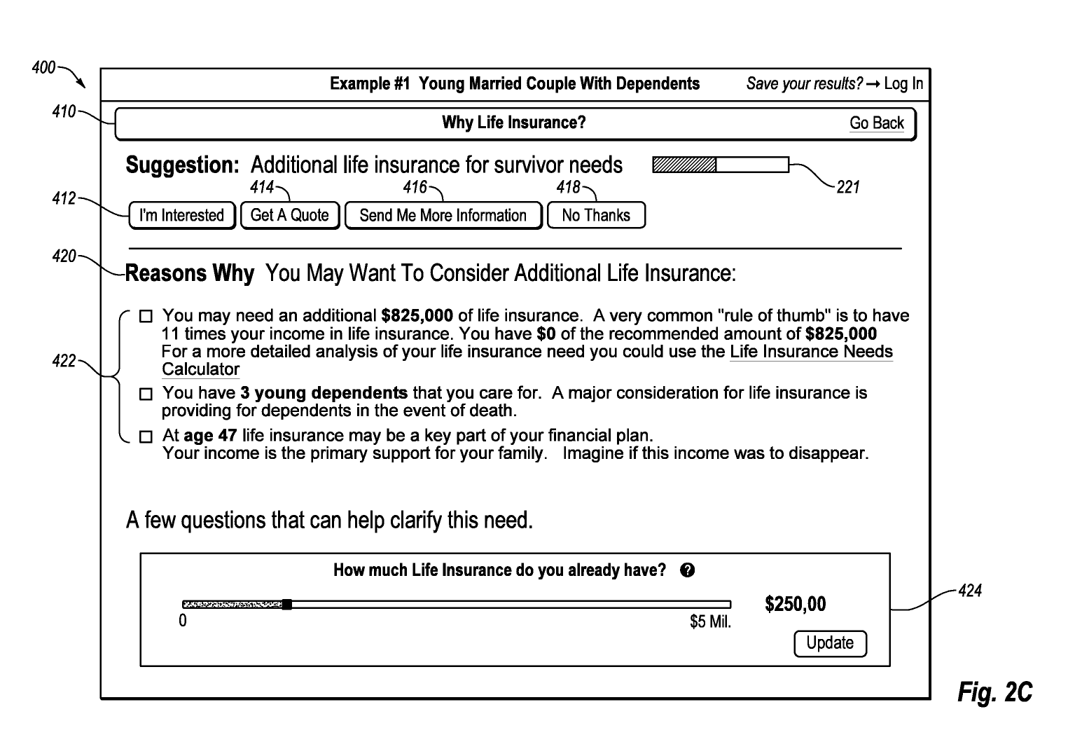

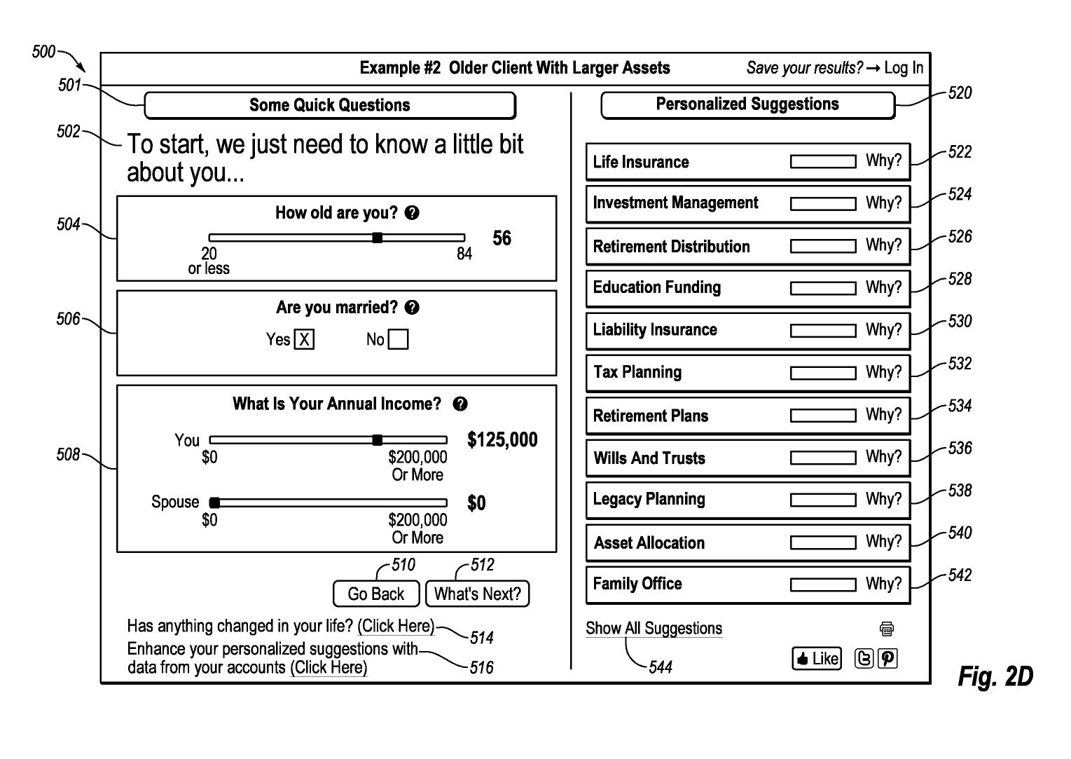

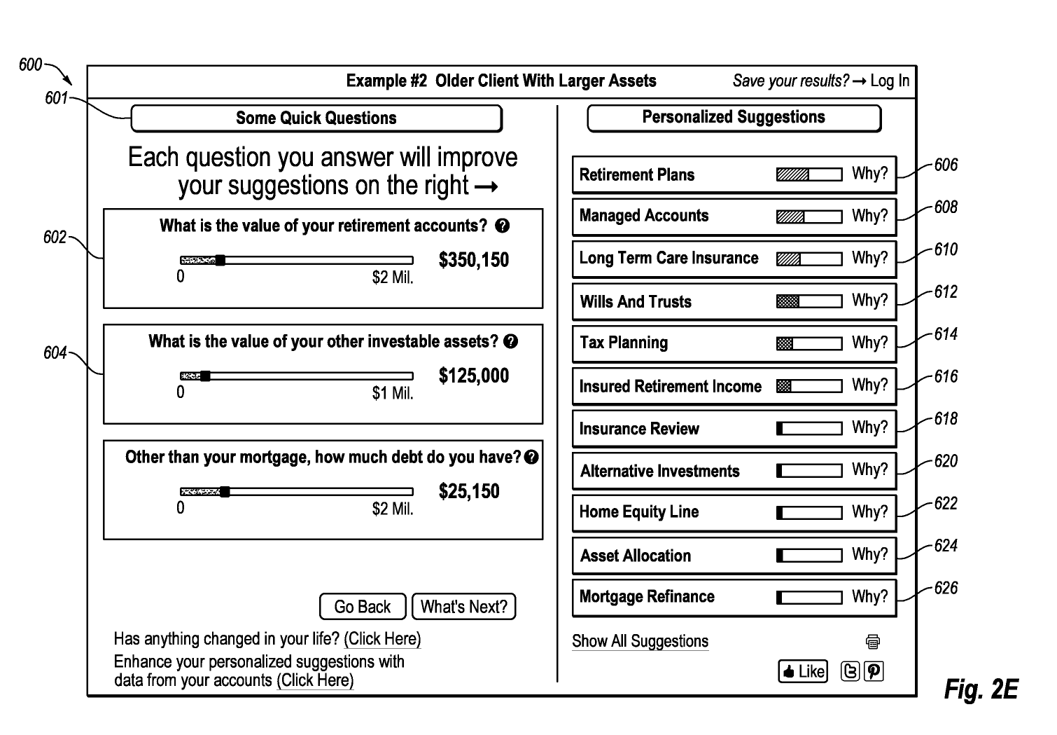

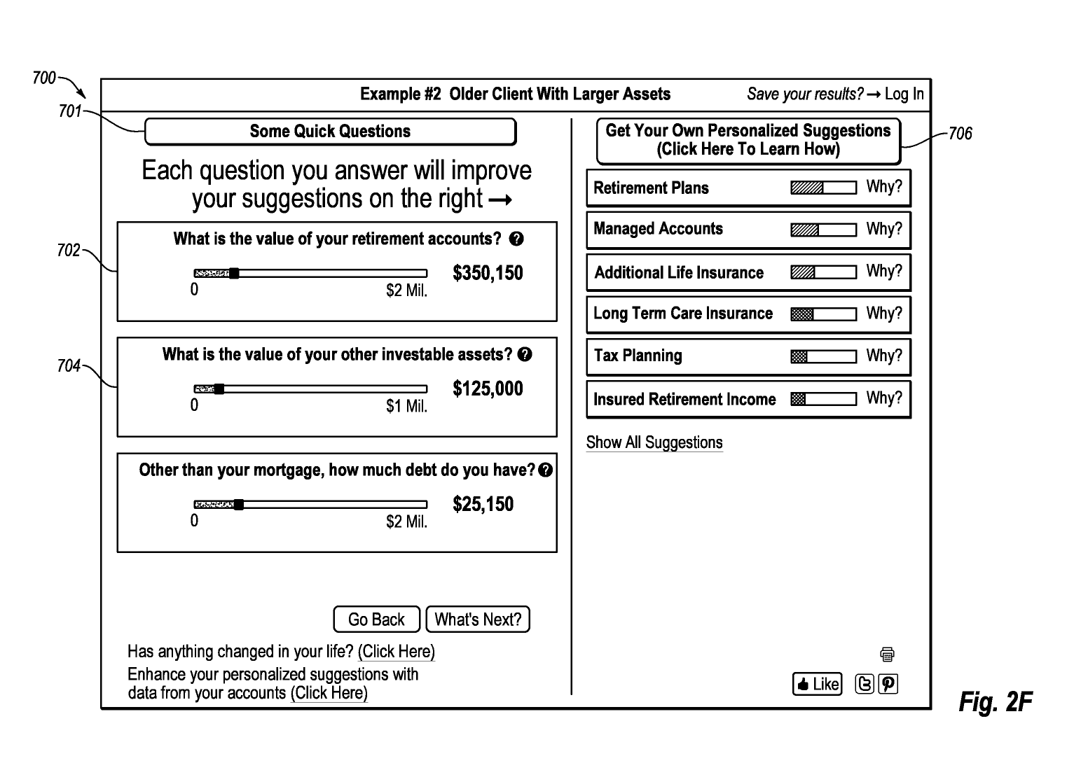

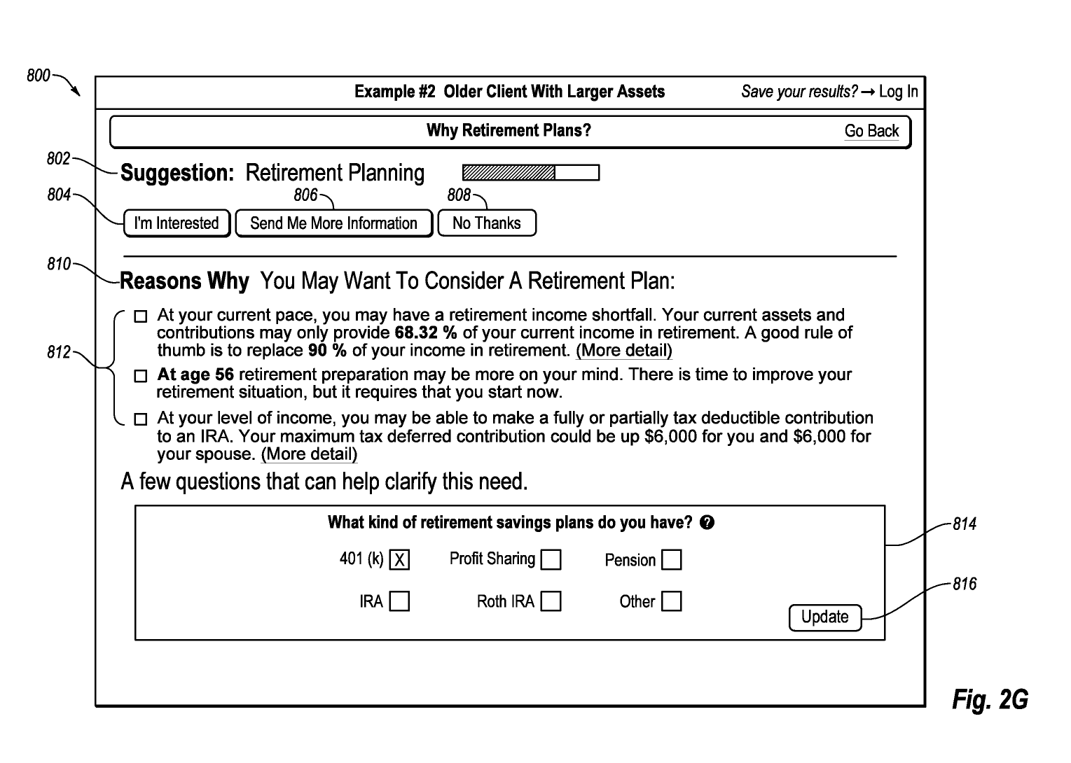

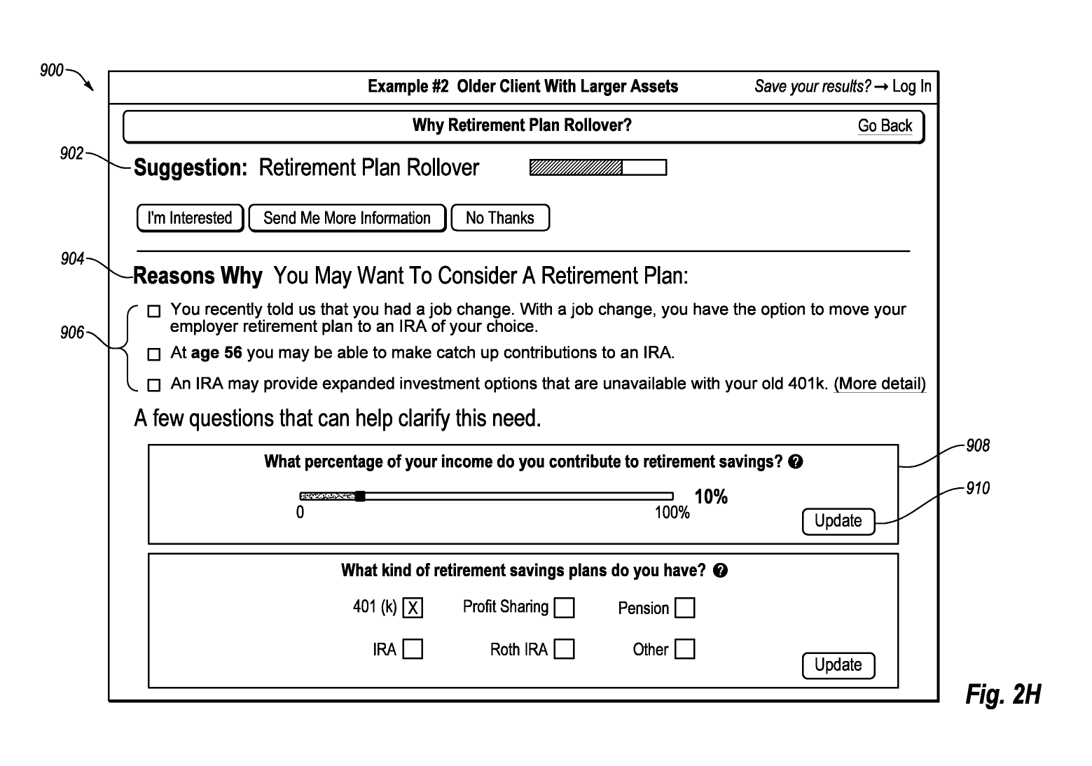

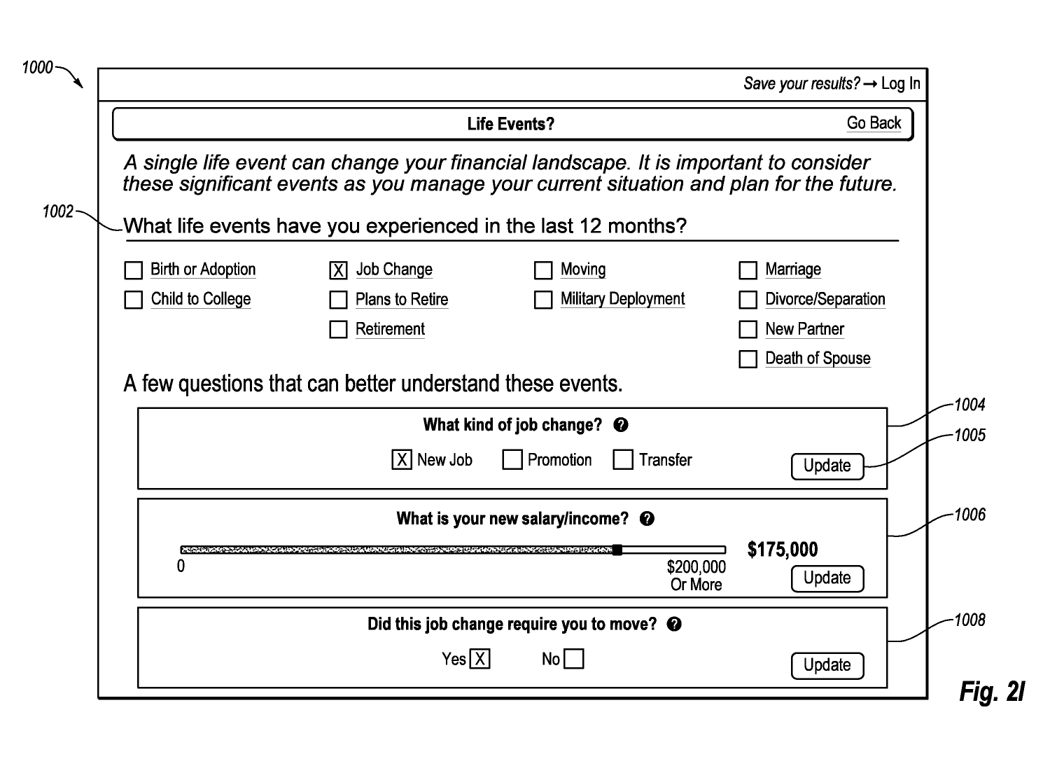

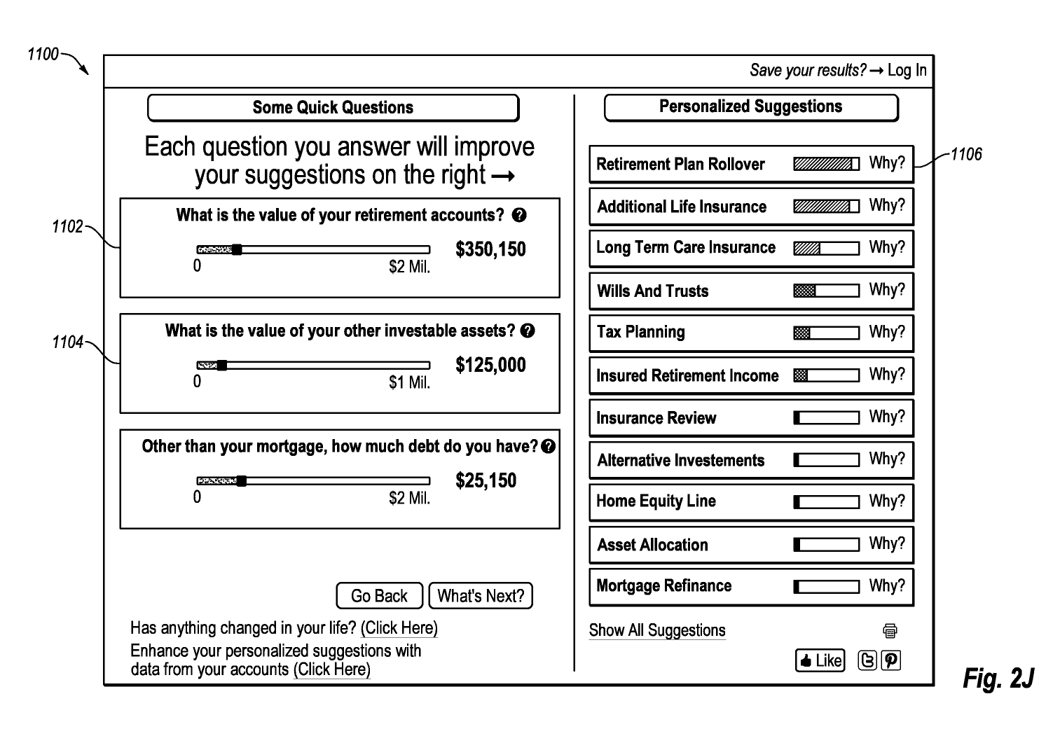

FIGS. 2A through 2J are screen shots provide an example of the types of input and output that may be provided by the system. More specifically, FIGS. 2A-2C illustrate an example of a financial planning recommendation session that a young married couple with dependents might experience using the method and system described herein. As shown in FIG. 2A, the user(s) log into the system and are greeted with an initial series of questions 201, such as the user's age 202, marital status 204, and annual income 206. As the user enters this preliminary data, the personalized suggestions 220 on the opposing side of the screen are dynamically updated. In this example, the topics of life insurance 222, retirement plans 224, liability insurance 226, education funding 228, wills and trusts 230, tax planning 232, long term care 234, alternative investments 236, legacy planning 240, asset allocation 242, and mortgage refinance 244. Additional suggestions may also be shown by expanding the list by selecting link 246.

Upon answering the preliminary questions 201, the user may user the “what's next button” to advance to the screen or display 300 shown in FIG. 2B and throughout the session, the user may use the “go back” button to return to a previous screen to alter answers to the questions. Additionally, the system may include various social media links 248 which enable the users to share their personalized recommendations of the system to their friends or to recommend that their friends use the system for themselves.

In the display 200 shown in FIG. 2A, the personalized suggestions 220 include a graph 221 indicating the relevancy or suggested importance of the various financial planning tools. For example, because the users are a young married couple with dependents, the system preliminarily determines that it would be most advantageous or most strongly recommended for the user(s) to invest in life insurance for survivors 222.

As briefly mentioned above, after answering the preliminary questions 201 and receiving a set of preliminary recommendations, the user selects the button 248 to advance to screen 300 shown in FIG. 2B, where the user is presented with additional questions 302, 304 and 306 which request additional details pertaining to the couple's children and other assets. As described above with respect to claim 1, these questions 302, 304, and 306 are dynamic and are tailored so as to correspond to the information that the user has previously submitted. For example, because the user indicated at the previous screen that he or she was aged 45 and married, the system requests at 302 the ages and number of children that the couple have and the value of their assets, if any.

Based on the answers to the questions 302, 304, and 306, the personalized suggestions 220 are reevaluated and potentially re-ranked. Each of these recommendations or suggestions also has a hyperlink 223 which the user may select in order to expand the screen to the display 400 shown in FIG. 2C. For example, upon requesting “why” the system recommends life insurance by clicking on hyperlink 223, the display 400 displays a list of “reasons why” 420 the couple may want to consider additional life insurance, which includes a list of reasons which are specific to the couple themselves 422. For example, the system may explain how much life insurance is recommended using a life insurance needs calculator based on the number of dependents, income, evaluation of the user's assets, and user age.

The recommendation engine may ask further questions 424 at this time, including requesting how much life insurance the user already has. Finally, the system may provide a feedback and/or contact section, whereby a user may indicate that they are interested 412 in obtaining more life insurance, not interested in life insurance 418, request a quote 414 or additional information 416. As described above, the system may use this information to update the recommendations and/or forward the users information to a financial consultant or other entity for more information or as a potential lead.

FIGS. 2D-2H show a second case study corresponding to an example of a session which may be experienced by a user who is older and who has larger assets than the user of FIGS. 2A-2C. Similar to the initial set of questions shown in FIG. 2A, the session begins with the display 500, where a set of preliminary questions 501 are presented to the user.

As shown in display 500, in this example the questions 504, 506 and 508 are the same questions as were presented to the user of FIGS. 2A-2C. As the user answers the questions, unranked financial planning mechanisms 522-542 of the personalized suggestions 520 section are evaluated and ranked. As described above, the user proceeds to the next section by selecting button 512 and may return to a previous screen by selecting button 510, and hyperlink 544 may be used to expand the list of available suggestions.

The system may also store the user's previous sessions with the system using a unique login such that any answers previously submitted to the system are automatically updated in the display 500. This information may be modified or changed by the user, or the user may indicate that an event has occurred which may alter the user's financial situation by selecting hyperlink 514. Further, the system may also enable the user to import financial data directly from their financial accounts using hyperlink 516.

Upon entering the answers to the preliminary questions 504, 506, and 508, and proceeding to the next section using button 512, the user is presented with a preliminary ranking of personalized suggestions 606-626. In this example, the system preliminarily determines that retirement planning 606 is most highly recommended, followed by managed accounts 608, long term care insurance 610, wills and trusts 612, tax planning 614, insured retirement income 616, insurance review 618, alternative investments 620, home equity line 622, asset allocation 624, and mortgage refinance 626.

As the user answers additional questions 602 and 604, the personalized suggestions are continuously reevaluated and re-ranked according to their relevancy to the user's specific situation.

Although the example shown in FIG. 2E contains an extensive listing of personalized suggestions, in another embodiment, the recommendation engine may only contain a subset of suggestions 706 or only those which are determined to be above a predetermined level of relevancy or recommendation level to the user. For example, in display 700, based on the answers to questions 702 and 704, the system may only present the user with the six most relevant financial planning suggestions or only those which are determined to be over a predetermined level or relevancy to the user.

FIG. 2G illustrates a display 800 which may presented to the user upon the user requesting ‘why’ retirement plans are suggested. Similar to the specific recommendation shown in FIG. 2C with respect to the first user, in this example, retirement planning 802 is recommended based on the reasons 801 which are particularly relevant to the older client with large assets and a listing of user-specific reasons 812 are shown to the user.

As shown in FIG. 2G, this listing may also include ‘rule of thumb’ suggestions to the user. The recommendation engine may also present the user with additional questions 814 about the specifics of the user's retirement plans, if any exist. Once this information is submitted using button 816, the recommended financial planning solution may be updated based on this submitted information.

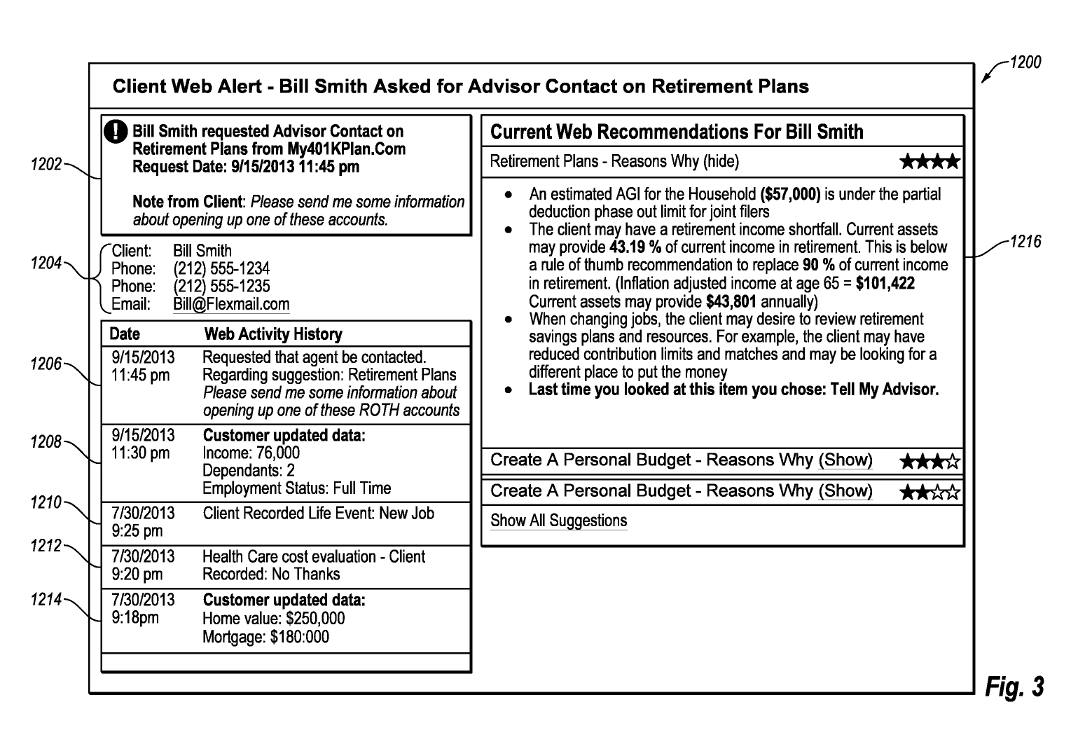

As described above, the display 800 may also include a feedback section whereby the user may indicate that he or she is interested in retirement planning, indicate that they are not interested in financial planning, and/or request more information using buttons, 804, 808, and 806, respectively. Upon receiving a request for more information using button 806, the system may send a web alert to a financial planning partner or other entity, such as will be described below with respect to FIG. 3.

FIG. 2H illustrates that additional information may be presented to the user for each of the various financial planning suggestions 902, along with additional reasons why they have been determined to be relevant to the user, with user-specific rationale 906. Further, additional questions 908 may continue to be presented which give the system an increasingly accurate portrayal of the user's current financial situation as it pertains to each of the different financial planning suggestions. The user may continue to submit this information using the tools 910 in order to receive increasingly personalized recommendations.

As described above, in some instances, the system may store a user profile which includes any information previously submitted to the system by the user and as described with respect to hyperlink 514 shown in FIG. 2D, may enable a user to submit information that relates specifically to a life changing event. FIG. 2I is a display 1000, whereby a user is able to enter information relating to the changes in life events.

As shown in FIG. 2I, the user is able to select which life events may have occurred since the user last utilized the system by selecting from a listing of common life events 1002. Once those life events have been selected, a series of relevant questions 1004, 1006, and 1008 are presented to the user for additional information. The user may then request updated recommendations based on the new events using button 1005.

Based on the new information, the system may present the user with display 1100, which now includes updated personal information and updated personalized suggestions. For example, in the display shown in FIG. 2J as compared to FIG. 2E, while the user's answers to the preliminary questions 1102 and 1104 remain unchanged, the user's new job and increased salary causes the recommendation engine to determine that a retirement plan rollover 1106 is the most pressing financial planning suggestion for the user to consider.

As may be understood by one of skill in the art, these examples of user sessions are meant to merely illustrate the various capabilities and functionality of the system and are not intended to limit the various aspects of a user interface or widget which may be used to ask the questions, receive answers from the user, and display a listing of personalized recommendations using the recommendation engine. Other features or user interfaces may be used without departing from the meaning and scope of the invention.

FIG. 3 shows an example of an electronic message that may be sent to a financial agent. In this example, an alert 1200 is sent to a party which provides or is otherwise affiliated with retirement planning. The alert may include identifying and timestamp information 1202, contact information for the user 1204 along with a listing of potentially relevant web activity 1206, 1208, 1210, 1212, 1214, which may enable the financial agent to provide more meaningful assistance and information to the user.

Further, the web alert may also provide a listing 1216 of what has already been recommended to the user along with user-specific reasons why those recommendations were made.

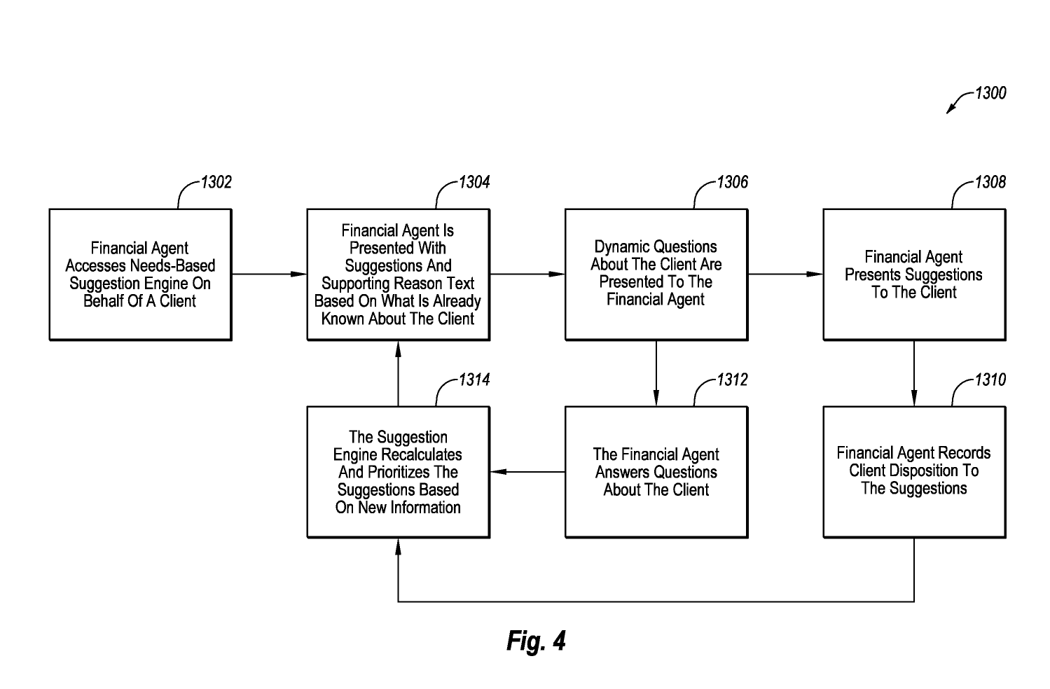

In the examples described in FIGS. 2A-2J and 3, the system is described as a widget or other user interface which may be accessed directly by the user. In an alternative embodiment shown in FIG. 4, the system may be used by a financial agent on a user's behalf. In the method 1300 shown in FIG. 4, the financial agent may access the needs-based system on a user's behalf at 1302. At 1304, the financial agent is presented with suggestions and supporting reason text and explanation based on what is already known about the client. As described above, this process may include the financial agent answering a set of preliminary questions about the client or may have submitted a preliminary set of data about the client. In another configuration, the client may have previously answered questions or submitted data about themselves. At 1306, dynamic questions about the client are presented to the financial agent. At 1312, the financial agent may opt to answer the dynamic questions about the client, causing the suggestion engine to recalculate and re-prioritize the suggestions based on the newly submitted information at 1314. At 1308, the financial agent presents the suggestions to the client. At 1310, the financial agent records the client's disposition to these suggestions, and the client's disposition may then in turn be used to recalculate and reprioritize the suggestions at 1314.

Hence, the system and method described herein may be used as a part of an integrated financial recommendation system that may be used by a financial planner or an associated entity. As may be understood by one of skill in the art, the needs based system enables a financial agent to provide meaningful suggestions based on the client's specific needs while providing enough personalization so that the system may continue to adapt based on the user's continuing needs and preferences.

The method of providing needs-based suggestions to at least one user described herein may include requesting financial or personal information to obtain key data, analyzing key data to determine and prioritize suggestions and providing an explanation or reason for each suggestion. The method may be implemented, in whole or in part, by a processor or other processing device, such as the system described with respect to FIG. 1.

The request for the financial or personal information may include a questionnaire asking for information pertaining to the key data about the user. For example, a prompt may be provided to the user including questions about age, marital status, annual income for the individual and, if applicable, the individual's spouse. The request may also include general questions providing a link to more detailed questions that are used by the system to generate more specific questions.

Additionally or alternatively, the key data may be obtained from information associated with an online account or a personal financial management system by having the user log in to the system. If the information obtained from the account information is insufficient, one or more questions may be configured to obtain the key data. The questions may be used to determine one or more follow up questions based on answers to the previous questions, thus, minimizing the input to generate client specific suggestions.

The key data obtained from the request may be analyzed to generate and prioritize suggestions. For example, the suggestions may be ranked by a meter, numbers or stars indicating the relevance of each suggestion. As non-limiting examples, the suggestions may include retirement plans, managed accounts, long term care insurance, wills and trusts, tax panning, insured retirement income, insurance review, alternative investments, home equity line, asset allocation, mortgage refinance, and the like.

The method may further include explaining why the suggestions are recommended for the user. For example, a detailed explanation of why the suggestion was made including client specific information and calculations may be generated and provided with the suggestions.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

Further, the embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for generating needs-based suggestions, comprising:
a computing device configured to perform operations comprising:
gathering key financial data for at least one user;
analyzing the key financial data to perform at least one of generating questions directed at identifying additional key financial data and selecting at least one suggestion based on the key financial data; and
generating an electronic message including the at least one suggestion and a detailed explanation of reasons the at least one suggestion was selected based on the key financial data.

2. The system of claim 1, further comprising a user interface for gathering the key financial data for the at least one user.

3. The system of claim 1, further comprising a memory capable of storing the key financial data in association with a user identifier which is associated with the at least one user.

4. The system of claim 1, wherein gathering key financial data for at least one user comprises presenting a series of preliminary questions and receiving answers to the series of preliminary questions.

5. The system of claim 1, wherein the detailed explanation of reasons the at least one suggestion was selected includes a listing of user-specific reasons why the one suggestion was selected with relevant key financial data of the key financial data.

6. The system of claim 1, wherein generating the at least one suggestion further comprises generating further questions directed at identifying and requesting further data as it pertains to the at least one suggestion.

7. A processor configured to execute computer instructions to cause a system to perform operations to determine at least one suggestion, the operations comprising:
gathering key financial data for at least one user;
analyzing the key financial data to perform at least one of generating questions directed at identifying additional key financial data and selecting at least one suggestion based on the key financial data; and
generating an electronic message including the at least one suggestion and a detailed explanation.

8. The processor of claim 7, further comprising providing a user interface for gathering the key financial data for the at least one user.

9. The processor of claim 7, further comprising storing the key financial data in a memory connected to the processor, the key financial data including a user identifier which is associated with the at least one user.

10. The processor of claim 7, wherein gathering key financial data for at least one user comprises presenting a series of preliminary questions and receiving answers to the series of preliminary questions.

11. The processor of claim 7, wherein the detailed explanation of reasons the at least one suggestion was selected includes a listing of user-specific reasons why the one suggestion was selected with relevant key financial data of the key financial data.

12. The processor of claim 7, wherein generating the at least one suggestion further comprises generating further questions directed at identifying and requesting further data as it pertains to the at least one suggestion.

13. A method for generating at least one suggestion, comprising:
requesting financial or personal information to obtain key data relating to at least one user;
analyzing the key data to determine suggestions relevant to the at least one user;
prioritizing the suggestions in order of relevance to the at least one user based on the financial or personal information; and
providing at least one of an explanation and a reason for each suggestion.

14. The method of claim 13, wherein the financial or personal information is requested using a user interface which is accessible by a user or other entity authorized by the user.

15. The method of claim 13, further comprising storing the key financial data in association with a user identifier which is associated with the at least one user.

16. The method of claim 13, wherein requesting financial or personal information to obtain key data comprises presenting a series of preliminary questions and receiving answers to the series of preliminary questions.

17. The method of claim 13, wherein the at least one explanation of reasons for each suggestion includes presenting a listing of user-specific reasons why the at least one one suggestion was selected with relevant key financial data of the key financial data.

18. The method of claim 13, further comprising generating further questions directed at identifying and requesting further data as it pertains to the at least one suggestion.

19. The method of claim 18, further comprising obtaining further data as it pertains to the at least one suggestion, analyzing the further data, and re-prioritizing the suggestions in order of relevance to the at least one user based on the financial or personal information and the further data.

20. The method of claim 13, further comprising receiving a request for additional information and sending the request for additional information along with a subset of the key data to an entity capable of providing additional information.
